(19) United States
(12) Patent Application Publication
(10) Pub. No.: US 2014/0343740 A1
(43) Pub. Date: Nov. 20, 2014

(54) MODULAR CONTROL SYSTEM FOR A WIND TURBINE OR A WIND POWER PARK AND WIND TURBINE OR WIND POWER PARK WITH SUCH CONTROL SYSTEM

(71) Applicants: Anders Eriksen, Herning (DK); Knud Møller Andersen, Herning (DK); Steen Drejer Antonsen, Skanderborg (DK)

(72) Inventors: Anders Eriksen, Herning (DK); Knud Møller Andersen, Herning (DK); Steen Drejer Antonsen, Skanderborg (DK)

(21) Appl. No.: 14/373,062

(22) PCT Filed: Jan. 27, 2012
(86) PCT No.: PCT/DK2012/050034

§ 371 Date: Jul. 18, 2014

(51) Int. Cl. F03D 7/04; H04L 29/08

(52) U.S. Cl. CPC F03D 7/047; H04L 67/10
USPC 700/287

(57) ABSTRACT

A control system for a wind turbine or a wind power park is disclosed, comprising a plurality of control stations arranged in a hierarchical master/slave configuration using a real-time communication system, each comprising a generic control unit in the form of a fully equipped computer module and a generic power module, one of which is arranged to act as a gateway or interface for communication with other control stations one level higher or one level lower in the control station hierarchy, wherein one or more of the control stations further may comprise a dedicated control unit adapted to a specifically assigned control task and/or one or more I/O unit configured to receive inputs from and generate outputs to parts of the wind turbine outside the control system. Furthermore, a wind turbine and a wind power park comprising such a control system are disclosed.

### FIELD OF THE INVENTION

The present invention relates to a modular control system for a wind turbine or for a wind power park comprising a plurality of wind turbines as well as for a wind turbine and a wind power park comprising such a control system.

### BACKGROUND OF THE INVENTION

It is known from existing control systems for wind turbines or wind power parks, such as the ones disclosed in U.S. patent application Nos. US 2009/0309360 and US 2009/0309361, that such control systems may comprise a number of controllers, which are physically and configurationally distributed throughout different parts and systems within the wind turbine or the wind power park, and communicate with each other using more generic and commonly known communication systems, such as Ethernet systems, or more specified communication systems, which may be “custom made” for the specific control system.

A common drawback of known control systems are that once the system configuration has been determined, the capacity limits of the system, for instance with respect to the number of controllers, the computing capacity of the controllers and the amount of information being transmitted between the controllers, etc., are usually fixed and the system can only be expanded beyond those limits through a thorough and often cumbersome reconfiguration of the system.

It is an object of the present invention to provide a control system, which overcomes these disadvantages of systems known in the art.

### BRIEF DESCRIPTION OF THE INVENTION

The present invention relates to a modular control system for a wind turbine, said control system comprising a plurality of control stations distributed in the wind turbine to be controlled, one of which control stations is assigned to be a main control station, the others being assigned to be sub-control stations, the control stations being arranged in a hierarchical master/slave configuration using a real-time communication system, each of the control stations comprising a generic control unit in the form of a fully equipped computer module and a generic power module, one of which is arranged to act as a gateway or interface for communication with control units or power modules of other control stations one level higher or one level lower in the control station hierarchy, wherein one or more of the control stations further may comprise a dedicated control unit adapted to a specifically assigned control task and/or one or more I/O unit configured to receive inputs from and generate outputs to parts of the wind turbine outside the control system.

The system configuration of the present invention is advantageous in that it is infinitely scalable because, apart from adding more control stations to a given hierarchical level, it is always possible to add new levels to the control station hierarchy, either at the bottom level or at the top, the latter possibility including the introduction of a new main control station, the previous main control stations of one or more control systems now being slave(s) of the new main control station.

Often a wind turbine manufacture relies on a plurality of sub-suppliers to provide different parts of a wind turbine to be built. For instance, one sub-supplier is selected to provide the blades, another one is selected to provide the pitch system, a third one is selected to provide the control system, and a fourth sub-supplier is selected to provide the power converter, etc.

The task for the sub-supplier delivering the control system is to connect to each of the parts of the wind turbine to enable control of all the parts and thereby control of the entire wind turbine.

For a manufacturer of control systems supplying control systems for different wind turbine manufacturers, it is very advantageous to be able to use a scalable system configuration based on control stations comprising off-the-shelf hardware units to fulfil orders from different wind turbine manufactures rather than having to develop new control systems and configurations for each wind turbine manufacture.

It is also very advantageous to be able to build standard control stations comprising a generic control unit (also simply referred to as control unit) and a generic power module (also simply referred to as power module) and often also comprising one or more I/O units and/or a sensor unit and/or a dedicated control unit. The units of the control station are interconnected by means of wires, optical fibres or connected to each other by means of clicking the unit onto a suitable connector block.

It should be noticed that the individual units of the control station may be combined together into one or more casings. Furthermore, it should be noticed that in the following, sub-control stations may be are referred to as second, third, fourth layer control stations, etc.

In an embodiment of the invention, the real-time communication system is configured so that any given sub-control station is arranged to be able to communicate with other control stations using two real-time communication busses, the first of which is common to the given control station, its master control station one level higher in the control station hierarchy and other control stations at the same level as the given control station, which are also configured to operate as slave control stations of the same master control station, the second real-time communication bus being common to the given control station and control stations one level lower in the control station hierarchy, which are configured to operate as slave control stations of the given control station.

It is to be understood from the above that sub-control stations on the lowest level in their part of the control station hierarchy will only need to communicate upwards in the hierarchy with their respective master control station and/or to other sub-control stations on the same level in the control station hierarchy, which are slaves of the same master control station. This means that these control stations will only communicate via one real-time communications bus.

The use of a number of distributed busses together forming the real-time communication system means that the system may be seen as consisting of a plurality of building blocks, which can easily be combined in different ways, thus underlining the scalability and flexibility of the system.

In an embodiment of the invention, the generic control units of a plurality of the control stations, preferably of all the control stations, are identical in the sense that they have the same hardware configuration.

The use of identical generic control units reduces the cost price of the control system.

In an embodiment of the invention, the real-time communication system is a real-time Ethernet system.

Ethernet systems possess a number of technical characteristics, which make them very useful in systems like the present invention. Furthermore, Ethernet is a thoroughly tested technology, easy accessible and low in price and finally it is usable even in nosy environments and over large distances.

In an embodiment of the invention, substantially all of the real-time communication busses used in the real-time communication system are of the same type.

In an embodiment of the invention, the generic power modules of a plurality of the control stations, preferably of all the control stations, are identical in the sense that they have the same hardware configuration.

Again, using identical or similar parts in the control system reduces the cost price of the system.

In an embodiment of the invention, the control stations are arranged in such a way in the hierarchical master/slave configuration that data acquired by a given control station are stored and processed locally within that control station and, during normal operation, only necessary commands, requests and status information are sent from one control station via the common communication bus to another control station one level higher or one level lower in the hierarchy.

It should be mentioned that often it is desired to be able to store large amount of data, e.g. data from the last 24 or 48 hours. This log data is to be communicated to a data storage via the communications busses together with the control data. In case of congestion of the busses, the log data may be stored locally until the busses again are ready or free to communicate log data.

The use of fully equipped computer modules as the control units of the individual control stations makes it possible to distribute the computations and control related decisions between the control stations so that the traffic on the communication busses may be reduced significantly as compared to systems known in the art.

Hence the control system of the present invention may imply autonomous control of parts of the wind turbine or one or more of the individual wind turbines of a wind power park.

Furthermore, the risk of communication errors is significantly reduced by this configuration of the control system, and it becomes easier to locate faults, if and when they occur.

In an embodiment of the invention, the specifically assigned control tasks handled by one or more of the optional dedicated control units includes one or more of the control tasks on the following list: blade pitch control, yaw control and power converter control.

Any wind turbine or wind power park related control task may be handled by a dedicated control unit of the invention, such as for instance pitch and converter control in a wind turbine and startup, surveillance and control of active and reactive power in a wind power park.

In an aspect of the invention, it relates to a modular control system for a wind power park comprising a plurality of wind turbines, said control system comprising a plurality of control stations arranged in a hierarchical master/slave configuration using a common communication bus, at least some of the control stations being arranged to form one or more wind turbine control systems according to any of the preceding claims.

As indicated above, a number of wind turbine control systems may be combined in a single wind power park control system by letting the main control station of each of the wind turbine control systems be a slave of the main control station of the wind power park control system.

In an aspect of the invention, it relates to a wind turbine comprising a modular control system as described above.

In an aspect of the invention, it relates to a wind power park comprising a modular control system as described above.

### FIGURES

A few exemplary embodiments of the invention will be described in more detail in the following with reference to the figures, in which

FIG. 1 illustrates schematically an exemplary configuration of a modular control system according to an embodiment of the invention,

FIG. 2 illustrates schematically and in more detail a modular control system according to an embodiment of the invention, and

FIG. 3 illustrates a wind turbine with part of a modular control system according to an embodiment of the invention.

### DETAILED DESCRIPTION OF THE INVENTION

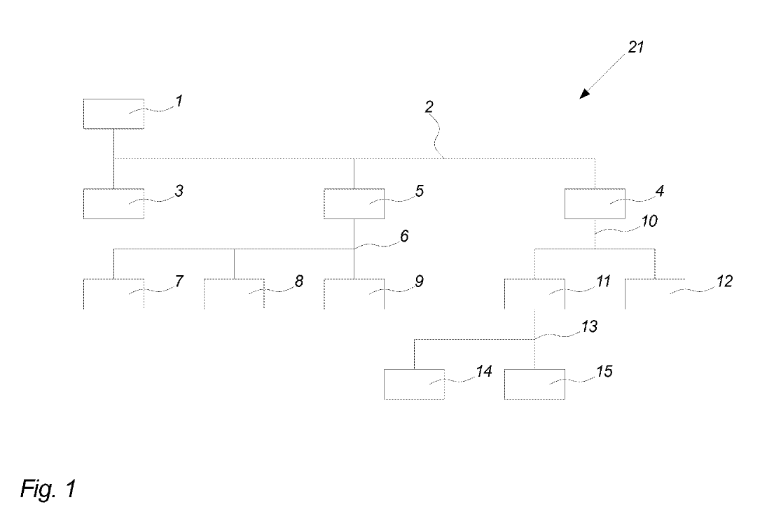

FIG. 1 illustrates schematically, how a control system 21 according to an embodiment of the invention may be configured with a number of control stations 1, 3-5, 7-9, 11, 12, 14, 15 communicating via a real-time communication system comprising real-time communication busses 2, 6, 10, 13.

On top of the hierarchy is a main control station 1, which is connected to each of its slave control stations 3-5 in the second layer of the control station hierarchy through a real-time communication bus 2.

Two of the second layer control stations 4, 5 are connected to three 7-9 resp. two 11, 12 slave control stations in the third hierarchical layer through respective real-time communication busses 6, 10.

Finally, one of the third layer control stations 11 is connected to two slave control stations 14, 15 in the fourth layer of the control station hierarchy through yet a real-time communication bus 13.

Hence the main control station 1 is master to its slaves, which are the sub-control stations 3-5.

The sub-control stations 4 and 5, in turn, are masters to their slaves, which are the sub-control stations 7-9 and 11-12, respectively. The sub-control stations 4 and 5 are communicating with each other, control station 3 and up in the control station hierarchy to the main control stations 1 via a common first real-time communication bus 2, and the sub-control stations 4 and 5 are communicating down in the control station hierarchy to sub-control stations 7-9 and 11-12, respectively, via second real-time communication busses 6 and 10, respectively.

The sub-control station 11 is master to its slaves, which are the sub-control stations 14 and 15. The sub-control station 11 is communicating with sub-control station 12 and up in the control station hierarchy via a first real-time communication bus 10, and the sub-control station 11 is communicating down in the control station hierarchy to sub-control stations 14 and 15 via a second real-time communication bus 13.

The individual sub-control stations 3-5, 7-9, 11, 12, 14, 15 may be dedicated to controlling and/or monitoring different parts of the wind turbine or wind power park, such as the pitch system, the power converter, the condition monitoring, etc.

Further, the sub-control stations 3-5, 7-9, 11, 12, 14, 15 may be used for temporary or permanent local data storage or for controlling such storages.

Any control station 1, 3-5, 7-9, 11, 12, 14, 15 may comprise a data storage so that it is possible to store data locally instead of sending all data to a central data storage. In this way, the generic control unit 16 or dedicated control units 19, 20 do not need to use the communication busses to retrieve logged data during normal operation of the control system. This could motivate storage of data in a higher resolution compared to the case with central data storage.

The control system 21 is modular and infinitely scalable, because any of the control stations 3, 7-9, 12, 14, 15, which do not already have any slave control stations, may be equipped with a real-time communication bus connecting it to one or more sub-control stations being configured as slaves of the given control station. Further, for the control stations 1, 4, 5, 11 already connected to a second real-time communication bus it is possible to add more sub-control stations.

Likewise, the main control station 1 and other (not illustrated) control stations may be connected via a real-time communication bus to a higher-ranking control station via a real-time communication bus to act as slave(s) for that control station.

Thus, the control system 21 may be considered as consisting of a main control station 1 and a number of modules or building blocks each comprising a real-time communication bus 2, 6, 10, 13 and one or more sub-control stations 3-5, 7-9, 11, 12, 14, 15.

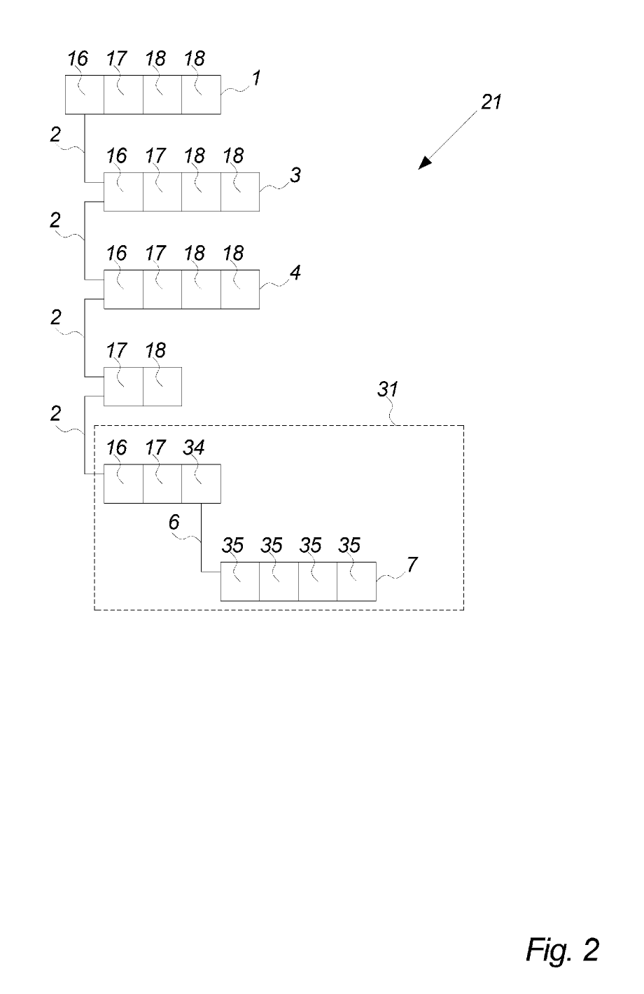

Further each of the control stations 1, 3-5, 7-9, 11, 12, 14, 15 may be considered as consisting of building blocks in form of generic control units 16, I/O units 18, dedicates control units 19, 20, etc., as described further below in relation to FIG. 2.

The division of the communication system into different real-time communication busses 2, 6, 10, 13 means that any given control station 1, 3-5, 7-9, 11, 12, 14, 15 will only see the information that is relevant for that specific control station, whereas the over- or underlying parts of the communication system will be hidden for that specific control station.

For instance, the main control station 1 in FIG. 1 will not see the communication on the busses 6, 10 between the second layer control stations 4, 5 and the underlying parts of the control system 21. This means that information will only be passed through the parts of the control system, in which they are relevant. When appropriate, any information on a communication bus 2, 6, 10, 13, which is relevant for control stations not connected to this specific bus 2, 6, 10, 13 may be passed through a control station 4, 5, 11 to another bus 2, 6, 10, 13 further up or down the hierarchical control station structure.

A real-time communication system is to be understood as a deterministic system in which it is possible to predict the time of arrival of a data packet. Thus, an advantage of a real-time communication system as described is that the period of time between subsequent transfers of data packets in the system is known. Hence, if a data packet is send to a receiver but, for some reason, is not received there, the data packet will be sent once more and can be expected to arrive at the receiver one such time period later. Some types of real-time communication systems belong to a category, which is known as industrial Ethernet. More information on such systems may be found in the IEC 61158 fieldbus standard.

A hierarchical control system 21 enables autonomous control of parts of a wind turbine. For instance, it is possible to place an autonomous control station in the hub for controlling the rotor, which only requires input, e.g., for calculation of a pitch angle, the rotation speed of the rotor, etc. When the control stations 1, 3-5, 7-9, 11, 12, 14, 15 communicate via busses 2, 6, 10, 13, the use of autonomous control stations lowers amount of data to be communicated on the busses 2, 6, 10, 13. This is very advantageous because this leaves the busses 2, 6, 10, 13 available for other communication purposes. Furthermore, it is advantageous that the sub-control stations 3-5, 7-9, 11, 12, 14, 15 do not always have to communicate with the main control station 1 to get permission or results before performing control or monitor operations, but may handle many situations on their own.

A wind turbine control system 21 according to the present invention, which is based on a scalable platform is easy to modify to make it comply with technical or cost reducing demands, e.g., from a wind turbine manufacturer. Cost reduction could be achieved, e.g., by adding new principles for controlling the rotor, converter etc. Such new principles could require a whole new way of controlling parts of the wind turbine and such new control could be implemented according to this invention by connecting an appropriate dedicated control station to the communication bus. Contrary to this, in other known control systems the introduction of control according to such new principles would require changes in a central control station. Such changes could escalate and may even affect other parts of the wind turbine which was not aimed at.

FIG. 2 shows a part of a control system 21 according to an embodiment of the invention in more detail and illustrates how each of the control stations 1, 3-5 comprises a generic control unit 16 and a generic power module 17. The term ‘generic’ indicates that the control units 16 may all be identical, at least when it comes to the hardware, and the same goes for the power modules 17.

Each of the control stations 1, 3-5 illustrated in FIG. 2 also comprises one or two I/O units 18. These I/O units 18 are used for sending commands and receiving responses and data from parts of the wind turbine or wind power park, which are not part of the control system 21, such as pitch actuators, power stacks, yaw motors, cooling circuits, drive train, etc.

The last of the second level control stations 5 in FIG. 2 is shown to comprise a dedicated control unit 19, which is connected to another type of dedicated control units 20 via the communication bus 6. For instance, the dedicated control unit 19 in the second layer control station 5 may be a power converter control unit, and the dedicated control units 20 may be power stacks control units, or the dedicated control unit 19 may be an overall pitch control unit, the other dedicated control units 20 being pitch control units for each of the three blades of a wind turbine.

FIG. 2 illustrates how a number of control stations 1, 3-5 may be connected to a common real-time communication bus 2, 6 like beads on a string and each of the control stations 1, 3-5 may consist of a number of smaller units 16-20 together enabling control of at least part of the wind turbine. It should be emphasized that the order, in which these units 16-20 are illustrated in the individual control stations 1, 3-5 does not necessarily correspond to the order in which the units 16-20 are arranged physically in the control stations 1, 3-5. For instance, although the bus communication is controlled by the generic control units 16 of each control station 1, 3-5 the busses 2, 6 may be physically connected to the generic power modules 17 of the control stations 1, 3-5 the communication signals being connected to the generic control units 16 through the generic power modules 17.

Furthermore, the dedicated control units 20 are illustrated as being grouped together, whereas each of them could also be separately connected to the communication bus 6.

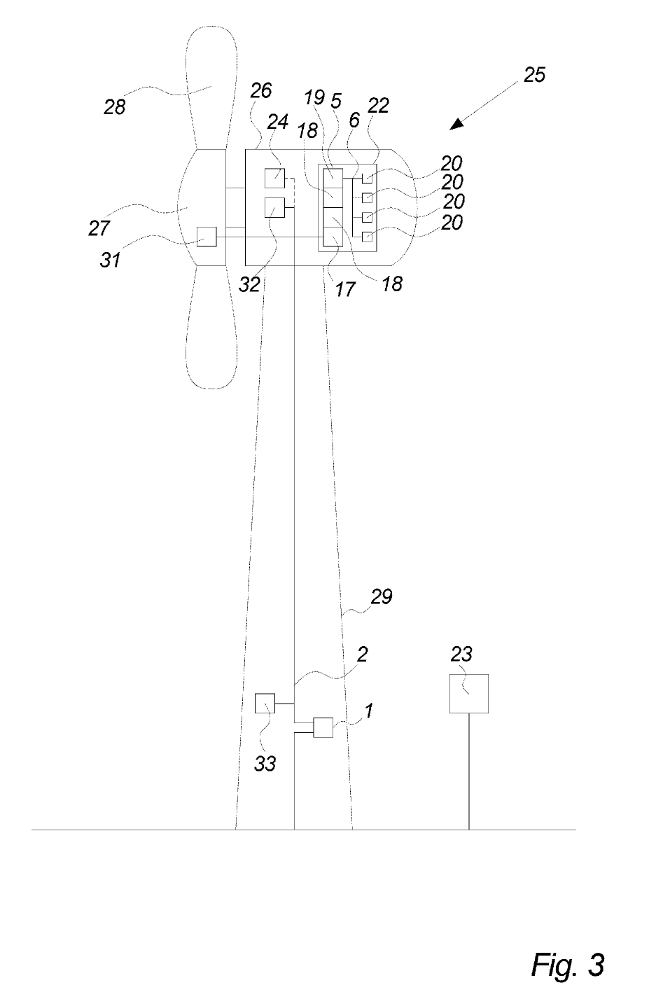

From the above, it is obvious that the units 16-20 in a control station 1, 3-5 could be arranged in any physical order, which may be decided by the physical layout of the panel, in which they are mounted, the location of the connection to the communication bus or the location of the part of the wind turbine 25 (see FIG. 3), which they are to control. Furthermore, units such as a dedicated control unit, e.g., the dedicated control units 20 could be located spaced apart from the rest of the control station 5.

FIG. 2 illustrates schematically one of the benefits achieved from the present invention. If, for instance, a new rotor or generator technology enables a wind turbine to increase its power production, e.g., by optimizing the pitch control through adding one or more pitch motors for each blade, one way of complying with this new demand for pitch control is simply to add a number of pitch motor control units 35 corresponding to the number of new pitch motors to the dedicated pitch control unit 34 in the pitch control station 31. Another solution might be to add further pitch control stations 31, so that there would be such a control station 31 for each blade. This is also part of the advantageous features of the scalable control system 21.

The I/O units 18 may be of many different types from simple ON/OFF relays to computerized modules with built-in intelligence and local decision-making. In fact, the generic power modules 17 may consist of I/O units 18 with specific and dedicated functions. In an example, the power module 17 may control the temperature on different components to ensure the right operation conditions for that component before startup. In this example, the generic power module 17 is capable of receiving input from a temperature sensor.

Although most of the I/O units 18 illustrated in FIG. 2 form part of a control station 1, 3-5 it is also indicated that an I/O unit 18 may be arranged together with a generic power module 17 on the real-time communication bus 2 but physically apart from a control unit 16 or dedicated control unit 34, 35, by which it is controlled. As an example, a control station controlling the pitch of the blades of the wind turbine may have distributed I/O units 18 located near each of the blades.

To sum up, the control system 21 comprises control stations 1, 3-5, 7-9, 11, 12, 14, 15, such as control stations for controlling converter, pitch, way, rotor, generator, measurements, sensors, etc. Each of these control stations 1, 3-5, 7-9, 11, 12, 14, 15 comprises a power module, preferably a generic power module 17, and a control unit, preferably a generic control unit 16.

Furthermore, these control stations 1, 3-5, 7-9, 11, 12, 14, 15 may comprise I/O units, preferably generic I/O units 18 and/or dedicated control units 19, 20 and/or storage units and/or measuring units, etc.

Hence, the control unit 16 may be seen as the platform on which the wind turbine control system 21 is built enabling autonomous control of different parts of the wind turbine 25. This is underlined by the fact that the hardware configuration of the control units 16, which are controlling each of the control stations, may be identical whether it is the main control station 1 or sub-control stations 3-5, 7-9, 11, 12, 14, 15.

The control unit 16 comprises a fully equipped computer module developed to control one or more wind turbines 25. Because the control unit 16 is developed specifically to control wind turbines, it has been possible to remove all unnecessary functionalities in order to limit the costs and physical extents and, thereby, dedicate all processor power of the control unit 16 to wind turbine control operations. This is different from state of the art control systems based on, e.g., a PLC platform or other multiple purpose control units, which are developed to facilitate control of a plurality of different machines.

In an embodiment of the invention the dedicated control units 19, 20 could be seen as intelligent I/O modules 18. Preferably, in terms of hardware, the dedicated control units 19, 20 are developed to solve only the task to which they are dedicated. This follows the same principle as for the development of the control unit 16 to limit cost and physical extent and to be able to dedicate all processor power to the dedicated task. The dedicated control units 19, 20 may be dedicated for the specific control of pitch actuators, power stacks, yaw, data storage, units for monitoring and/or analyzing grid, etc. The control unit 16, generally spoken, is designed to control the overall pitch, power converter, yaw, data storage, units for monitoring and/or analyzing grid, etc.

FIG. 3 illustrates a wind turbine 25 comprising a part of the control system 21 according to an embodiment of the invention. The wind turbine 25 further comprises a tower 29, a nacelle 26, a hub 27, blades 28 and a power converter 22.

The illustrated parts of the control system 21 comprise a main control station 1, a converter control station 5, a pitch control station 31, a condition monitoring control station 32 and a further control station 24 for controlling other parts of the wind turbine 25. The main control station 1 may sometimes be referred to as a wind turbine control station and is connected to the converter control station 5 and the condition monitoring control station 32 via a real-time communication bus 2.

The converter control station 5 comprises a power module 17 for energizing the converter control station 5, a generic control unit 16 for controlling the converter control station 5, a dedicated control unit 19, which is dedicated to control a power converter 22, and an I/O unit 18, through which communication is established with cooling system, temperature sensors, etc., from which the dedicated control unit 19 needs input.

The dedicated power converter control unit 19 communicates via a real-time communication bus 6 with one or more further dedicated control units 20, which, in the illustrated case, control the power stacks of the power converter 22.

An additional control station 24 is illustrated to indicate that, if necessary, it is possible simply to add one or more additional control station 24 on a lower level with very limited impact on the existing control system 21 as described above. This could be relevant, for instance, if a part of the wind turbine is replaced or a new part is added.

A pitch control station 31 is illustrated in the hub 27 for illustrating the autonomous control by individual control stations enabled by the present invention. As mentioned above, the pitch control station 31 may control the pitch or even the entire rotor based only on reference data from the main control station 1 to which the pitch control station 31 also would return information relevant for the main control station 1.

It should be noted that as the pitch control station 31 sends or receives data from the main control station 1, it is simultaneously capable of calculating pitch angles and communicating with the pitch actuators to adjust the pitch angles. This is due to the dedicated control unit (not illustrated) comprised by the pitch control station 31

A condition monitoring station 32 is also illustrated in the nacelle 26. The condition monitoring station 32 is controlling different sensors monitoring parts of the wind turbine 25. In an embodiment of the invention, the monitoring data is stored in the condition monitoring station 32 and in another embodiment the condition monitoring station 32 communicates the monitoring data to a data storage 33 when the communication bus 2 is available or uses an alternative way to communicate data to the data storage 33. As described above, the present invention also enables adding a control station to a higher level. This is illustrated with the new main control station 23 outside the wind turbine 25, which new control station 23 may be a wind park control station, which will then constitute the highest (first) level making the wind turbine control station 1 a slave control station on a second level in the hierarchy.

Hence, the description of FIG. 3 serves to illustrated examples on how the control system 21 of the invention is scalable both up and down.

It should be emphasized that the scope of the present invention is not restricted to the description above, which represents a few exemplary and illustrative embodiments only, whereas the scope of the invention is defined by the following claims.

The power module 17 is more than simply a power module as will be described in the following.

The power module 17 may have integrated supervision circuit, which controls the application processor, e.g., the generic control unit 16 and the dedicated control units 19, 20 in relation to temperature, unstable supply, power up/down and watchdog functions.

One example of the controls performed by the power module 17 is controlling the temperature inside a control station which may be regulated by activating a heating element and/or a ventilator. Another example is the provision of power to the generic and dedicated control units 16, 19, 20, which is controlled by a supervision circuit (which is part of a safety loop). Furthermore, if the power source is an uninterruptible power supply (UPS), the power module 17 may be equipped with a sleep mode for power saving.

In short, the power module 17 may further comprise: local temperature measurement, heat and ventilation control, power regulation for internal supply and for a safety relay, power regulation for computer modules, such as the generic and dedicated control units 16, 19, 20, and IO modules, communication interface to master control station and/or one or more sub-control stations with fibre optic interface, LVDS (low voltage differential signalling) interface to locally attached modules, safety-loop relay, emergency stop and safety loop status input, watch dog function via RS485 for modules connected to the power module 17 and CAN bus for communication with UPS and battery management. Some of these functions will now be described in further details.

The power module 17 may control the power supplied to the control station of which it is a part, and take decisions regarding power input quality and surrounding temperature.

The Power module 17 may be equipped with two temperature sensors. The first one may be placed to enable it to measure the ambience temperature of the control station. In addition, it may control the ‘CPU heat’ resistors. In this case, when power is applied to the system, while the temperature is below a minimum operating temperature of the data processor of the power module, the ‘CPU heat’ will be enabled by the first temperature sensor. In this way, it is possible always to start up the power module 17 at the right temperature. When the data processor is operational, the temperature of the control station is measured using the first temperature sensor. ‘Station Heat and ventilation’ is controlled in order to bring the temperature of the remaining system (generic control unit 16 and additional units, e.g., dedicated control modules 19 and 20) within operating temperature.

The power module 17 may monitor internal and external power supplies in the system.

The power module 17 may be equipped with an internal serial flash memory, which holds module identification (e.g. serial no., hardware and software version, etc.) and calibration data. The serial flash memory can also be used for event logging. Part of the serial flash memory may be write-protected so that writing to this area is only possible when an internal pin is activated under production test and calibration. The serial flash memory may store the reason for reset of a unit in the control station, information covering the latest reset reasons being part of the power module 17 event log or device profile.

The power module 17 may have a watchdog and reset function for one or more data processors of the units of the control station. If so, live signalling may be performed between the power module 17 and the data processors of a control station by exchanging status telegram over a serial communication channel, such as RS485. The power module 17 may initiate and maintain the communication. If the power module 17 or one of the data processors detects missing live signalling, shutdown will be performed. The safety loop then falls and the output is turned off after timeout. Power up is held until stable 5V supply and an energy storage holds sufficient energy for a full power down cycle. By power down, an early warning is distributed before cut off to the modules of the control station.

In an embodiment of the power module 17, it supplies the generic control unit 16 with 5V/3 A and the other units of the control station with 5 Vdc/10 A.

In an embodiment, the power module 17 may comprise outputs for emergency stop relays and for climate control, such as heat and ventilation (e.g. in the range about 24 Vdc/1 A). According to this embodiment, the temperature specification for this circuit part is from −40° C. (preferably −55° C.) to 90° C., and the emergency stop relay is supplied with 300 mA. The emergency stop relay is preferably on as default as soon as power is applied to the power module 17. Furthermore, it may be determined if thermal conditions are within specifications for the safety loop. The power module may have a turn off function (for cutting off supply to other modules), thermal shutdown (for cutting off supply to modules in case of temperature not falling within the specifications for these modules) and over current protection (for cutting off supply to modules in case of detecting over current).

In an embodiment, the power module 17 may communicate via a real-time communication system 21 to a master module (such as the generic control module 16), application modules (such as dedicated control modules 19, 20) and add-on modules (also sometimes referred to as application modules), such as I/O modules 18). Furthermore, the power module 17 may use an RS485 communication port for communication with application modules and add-on modules. Furthermore, the power module 17 may have a real-time communication system switch function for top level or slave function.

Generally, in relation to safety issues, vital decisions like output release and application module ready (e.g. if the safety loop is closed) require minimum two partners to agree for activation, and all partners have individual veto rights to deactivate. Here, a partner should be understood as modules communicating on the real time communication system 21, such as modules in a control station, e.g. the power module 17, generic control module 16, dedicated control module 19, 20 and I/O module 18. It should be mentioned that the safety loop may comprise a set of switches. The switches may be manually controlled (such as emergency switches) or they may be automatically controlled, e.g. by dedicated control modules for pitch, converter etc. During normal operation, the switches are closed and the safety loop is closed. If a fault occurs and one switch is opened, the safety loop is broken and the wind turbine control (e.g. the master control module) takes appropriate actions.

Output release and application module release may be hardwired. The power module 17 and the associated application modules 18-20 may be hooked up on the same logic-OR circuits. In case of fatal error (relating to hardware or software) in the power module 17 or in one of the application modules, the non-affected partner have the opportunity to signal “STOP” and switch off the output power. It should be noted that units not related to wind turbine control (e.g. switches indicating if doors and panels are closed) can be part of the of safety loop.

Safety loop switches from a plurality of control stations may be connected in series, and when all control stations are “ready”, the safety loop signal “active” may be distributed to all control stations/modules in the safety loop. Redundancy in the safety loop signalling is ensured in form of double signalling in case of faults. Hence, a fault will both be communicated via the real-time communication system and via the safety loop. It should be mentioned that the manual emergency stop signal may be distributed via real-time communication and via a further electric signal. Furthermore, it should be noted that the use of emergency stop and safety loop signalling is optional.

As part of the safety requirements to the control station, the “output enable” signal may be global for a control station. This means that all intelligent modules (i.e. modules having a data processor) in the control station can disable the outputs on the station in case security issue occurs. Furthermore, external input signals to the control station may also by part of the “output enable” signal. This input can be connected to any 24V signal. This enables, e.g., the safety loop or emergency stop dependent on output activation.

The power module 17 may facilitate early warning in case of extreme temperatures or power fall. Early warning is indicated prior to reset. Minimum time from early warning to reset ensure controlled shot-down including data save activities. If control stations require “long-life” after power down (e.g. for data processing, climate control, etc), this can be added in form of one or more external capacitors.

The power module 17 may facilitate reset. Via a reset button, service staff is given the opportunity to reset a control station in the field. Reset input activates software controlled power cycle of control modules, application modules and I/O modules.

Firmware of the power module 17 may be updated, e.g., via a real-time communication system from a master module. Firmware update of other modules of a control station may be initiated via communication with the power module 17. Hence, it is possible to request power cycle followed by forced wait for new firmware. If the power module 17 broadcasts an “in firmware update mode” signal after power up, no application modules leave their boot status. Instead, they wait for new firmware (complex modules may start reduced applications to be able to receive and store new firmware).

Some software functionalities of the power module 17 will now be described in further details.

The main state machine starts hardware initialization. It may then handle the power for the generic control unit 16 and other modules, such as dedicated control modules 19 and 20. Consideration of whether the temperature condition is within the respective specification may be made here. “Output enable” and safety loop may also be handled from the main state machine.

When the data processor of the power module 17 is powered up, it will go into an initialization state. The data processor and its peripherals (RAM, flash, Spi, I2C, Clocks, Gpio, Ade etc.) will be initialized, and hardware warnings or errors will be detected.

If an error is non-fatal, the data processor will attempt to power up the rest of the control station. Once the generic control unit 16 is running, the generic control unit 16 will be able to read detected errors (if any) of the power module 17 and act accordingly upon them.

An output enable signal will be activated when a “station ready” signal goes active to secure synchronous start of modules of the control station. The “output enable” signal will remain active while the system is running. “Output enable” is not used to inhibit the system. When the system is running and an event occurs that requires it to stop (e.g. the emergency stop button is pressed), it is up to a generic control unit 16 or the master control unit to safely shut down one or more control stations or modules of one or more control stations.

The power module 17 may be capable of controlling digital outputs, which may have dedicated functionality. For each digital output, the current may be monitored and a status bit may be set if the range and conditions for the current monitor is valid.

Thus, to sum up, the main tasks/functionality of the power module 17 are: to power the generic control unit 16, to power the application modules, i.e. dedicated control modules 19, 20 and/or I/O units 18, etc., to control the temperature of the control station, to handle the safety loop, to handle control station/panel ventilation, to handle fibre communication/media converter, i.e. to separate the control station from the rest of the real-time communication system, e.g. to separate the communication system in different master/slave levels.

### LIST OF REFERENCE NUMBERS

1. Main control station
2. Communication bus between first and second layer
3-5. Second layer control stations
6. Communication bus between second and third layer
7-9. Third layer control stations
10. Communication bus between second and third layer
11-12. Third layer control stations
13. Communication bus between third and fourth layer
14-15. Fourth layer control station
16. Generic control unit
17. Generic power module
18. I/O unit
19-20. Dedicated control units
21. Communication system
22. Power converter
23. New main control station
24. Additional control station
25. Wind turbine
26. Nacelle
27. Hub
28. Blades
29. Tower
30. Power converter cooling system
31. Pitch control station
32. Condition monitoring station
33. Data storage
34. Pitch control unit
35. Pitch motor control unit

What is claimed is:

1. A modular control system for a wind turbine, said control system comprising a plurality of control stations distributed in the wind turbine to be controlled, one of which control stations is assigned to be a main control station, the others being assigned to be sub-control stations,
the control stations being arranged in a hierarchical master/slave configuration using a real-time communication system,
each of the control stations comprising
a generic control unit in the form of a fully equipped computer module, and
a generic power module,
one of which is arranged to act as a gateway or interface for communication with control units or power modules of other control stations one level higher or one level lower in the control station hierarchy,
wherein the control stations are arranged in such a way in the hierarchical master/slave configuration that data acquired by a given control station are stored and processed locally within that control station and, during normal operation, only necessary commands, requests and status information are sent from one control station via the common communication bus to another control station one level higher or one level lower in the hierarchy.

2. A modular control system according to claim 1, wherein the real-time communication system is configured so that any given sub-control station is arranged to be able to communicate with other control stations using two real-time communication busses,
the first of which is common to the given control station, its master control station one level higher in the control station hierarchy and other control stations at the same level as the given control station, which are also configured to operate as slave control stations of the same master control station,
the second real-time communication bus being common to the given control station and control stations one level lower in the control station hierarchy, which are configured to operate as slave control stations of the given control station.

3. A modular control system according to claim 1, wherein the generic control units of a plurality of the control stations are identical in the sense that they have the same hardware configuration.

4. A modular system according to claim 1, wherein the real-time communication system is a real-time Ethernet system.

5. A modular control system according to claim 5, wherein substantially all of the real-time communication busses used in the real-time communication system are of the same type.

6. A modular control system according to claim 1, wherein the generic power modules of a plurality of the control stations are identical in the sense that they have the same hardware configuration.

7. (canceled)

8. A modular control system according to claim 9, wherein the specifically assigned control tasks handled by one or more of the dedicated control units includes one or more of the control tasks on the following list: blade pitch control, yaw control and power converter control.

9. A modular control system for a wind power park comprising a plurality of wind turbines, said control system comprising a plurality of control stations arranged in a hierarchical master/slave configuration using a common communication bus, at least some of the control stations being arranged to form one or more wind turbine control systems according to claim 1.

10. A wind turbine comprising a modular control system according to claim 1.

11. A wind power park comprising a modular control system according to claim 9.

12. A modular control system according to claim 3, wherein all of the generic control units of the generic control stations are identical in the sense that they have the same hardware configuration.

13. A modular system according to claim 6, wherein all of the generic power modules of the control stations are identical in the sense that they have the same hardware configuration.

14. A modular control system according to claim 1, wherein one or more of the control stations further comprise a dedicated control unit adapted to a specifically assigned control task and/or one or more I/O unit configured to receive inputs from and generate outputs to parts of the wind turbine outside the control system.

15. A modular control system according to claim 14, wherein said system comprises at least two dedicated control units each adapted to a specifically assigned control task, and wherein said specifically assigned control tasks of the at least two dedicated control units are different.

16. A modular control system according to claim 1, wherein said generic power module is configured to at least control the power supplied to the control station of which it is a part.

17. A modular control system according to claim 1, wherein said modular control system is configured to provide autonomous control of different parts of the wind turbine.

18. A modular control system according to claim 1, wherein said control stations are configured for controlling different parts of the wind turbine.

19. A set of control stations for a modular control system for a wind turbine,
said control system being configured to comprise a plurality of said control stations to be distributed in the wind turbine to be controlled, one of which control stations is configured to be assigned to be a main control station, the others being configured to be assigned to be sub-control stations,
wherein the control stations are configured to be arranged in a hierarchical master/slave configuration using a real-time communication system,
wherein each of the control stations comprises
a generic control unit in the form of a fully equipped computer module, and
a generic power module,
one of which is arranged to act as a gateway or interface for communication with control units or power modules of other control stations one level higher or one level lower in the control station hierarchy, and
wherein the control stations are configured to be arranged in such a way in the hierarchical master/slave configuration that data acquired by a given control station are stored and processed locally within that control station and, during normal operation, only necessary commands, requests and status information are sent from one control station via the common communication bus to another control station one level higher or one level lower in the hierarchy.

20. A set of control stations according to claim 19, wherein the hardware configuration of the generic control units for controlling each of the control stations are identical.

21. A set of control stations according to claim 19, wherein the generic power modules of the control stations are identical in the sense that they have the same hardware configuration.
